(19) United States
(12) Patent Application Publication
(10) Pub. No.: US 2022/0305639 A1
(43) Pub. Date: Sep. 29, 2022

(54) SMART STICK ASSEMBLY

(71) Applicant: Craig McManis, Manhattan Beach, CA (US)

(72) Inventor: Craig McManis, Manhattan Beach, CA (US)

(21) Appl. No.: 17/706,192

(22) Filed: Mar. 28, 2022

Related U.S. Application Data
(60) Provisional application No. 63/166,799, filed on Mar. 26, 2021.

(51) Int. Cl. B25J 1/04; B25J 19/02; B25J 15/06; B25J 18/02; B25J 19/00

(52) U.S. Cl. CPC B25J 1/04; B25J 19/023; B25J 15/0608; B25J 18/025; B25J 19/0008

(57) ABSTRACT

The present invention provides a smart stick assembly comprising a rod comprising a plurality of telescopic sections, wherein the rod having a proximal end and an opposing distal end. An illumination portion, disposed at the distal end of the rod, configured to illuminate. A camera, disposed at the distal end of the rod, configured to capture an image, or a video, or both. A sensor coupled to the camera to stabilize the camera during motion. The camera is configured to transmit the captured image and video to a remote communication device through the wireless transceiver. Further, detachable end effector coupled to the distal end of the rod and configured to perform an action.

### RELATED APPLICATIONS

This application claims priority under 35 U.S.C. 119 of U.S. Patent Application No. 63/166,799 filed Mar. 26, 2021, which is hereby incorporated by reference in its entirety.

### FIELD OF THE INVENTION

The present disclosure relates to a telescoping smart stick assembly used to capture images and/or videos, grab or pick up objects using an interchangeable end effector.

Magnetic pick-up tools are well known and widely used for retrieving dropped items such as nuts, bolts, screws, fasteners, tools and the like composed of magnetically susceptible materials from crannies inaccessible to hands and fingers. From distal end of rod to pick up a bolt or other metal fastening component such as a set of keys in a tight space surrounded by pipes, wires, and other obstructions, which are metal object. Prior art systems usually include distal ends that articulate via a cable or an actuator rod system. In most of the prior art systems the articulating distal ends are not held rigid in their angular position. Typical uses include picking up items from the ground, such as litter, for example, and for grasping items that would otherwise be out of reach, for example, items stored on shelves.

Some picking tools employ an actuator requiring the user to operation the tool by closing the fingers of one hand as a group, drawing the fingers toward the palm. However, since the same hand is holding the picking tool, this manner of operation puts an amount of strain on the user's wrist, such that long term use is uncomfortable, or such that the weight of items that can be picked up without wrist strain or pain is reduced considerably. Therefore, the device is requires having ability to grip or magnetic pick up the lost items where it cannot see due to darkness, out of reach, small hard to reach spaces for around corners.

For many years, both amateur and professional photographers and videographers have struggled with blurred images due to instability of the camera mounting, motion by the user, motion and vibration transferred to the camera from a mobile transport, or some combination of these issues.

Therefore, the replacement of selfie stick is requiring as it needs to place their expensive phones on the end of the stick where they can fall off. Accordingly, there is a need for improved smart stick that allows user to keep phone in their possession as well as control the image or video capture and zoom remotely.

### SUMMARY OF THE INVENTION

In accordance with the invention, an improved smart stick assembly with a camera and an interchangeable end effector for different uses is disclosed. The smart stick assembly is configured to capture images and/or videos of a hard to see or reach areas/objects.

According, it is an object of the present invention to provide a portable smart stick that is easy to use and light weight.

It is a further object of the present invention to provide an improved smart stick that is adapted for grasping a variety of items comfortably.

Another object of the present invention is to provide the smart stick that is configured to use with a communication device having a display to view the images and/or videos captured by the smart stick.

Yet another object of the present invention is to provide the smart stick that can be controlled by the communication device to capture image, and/or video, or grab, pick up objects using the interchangeable end effector.

According to one embodiment of the present disclosure, a smart stick assembly comprising a rod having a proximal end and an opposing distal end. The rod comprises a plurality of telescopic sections. The rod includes a battery, a charging port, and at least one printed circuit board. The at least one printed circuit board comprising a processor, a wireless module, and a memory. Further, the smart stick assembly comprises an illumination portion that is disposed at the distal end of the rod and is configured to illuminate when the camera is on/off position for the purpose of capturing an image or recording a video. The camera is configured to capture an image, video or both with minimal ancillary vibrations and motion via a sensor coupled to the camera. The camera is configured to transmit the captured image and/or video to the communication device through the wireless transceiver. Further, a detachable end effector is coupled to the distal end of the rod and is configured to perform an action. The detachable end effector is at least one of a magnet, robotic arm, and drill. Further, a control unit is disposed at the proximal end of the rod, and in operational communication with the detachable end effector, whereby the end effector is controlled directly from the rod.

In one exemplary embodiment, the smart stick assembly further comprises a rubber grip encapsulating at least a portion of the length of the rod. The rod comprises a metal material.

In one exemplary embodiment, the sensor is a gyroscope.

In one exemplary embodiment, the illumination portion comprises one or more light emitting diodes.

In another exemplary embodiment, the smart stick assembly further comprises a charging connector disposed between the battery and the charging port, wherein the charging connector is configured to enable electrical connectivity between the battery and the cable. The charging port of the rod comprises a USB port. Further, a cable is configured to detachably connect the communication device to the charging port of the rod.

In another exemplary embodiment, the smart stick assembly further comprises a switch operatively coupled to at least one of the illumination portion, the camera, and the wireless transceiver, wherein the switch is configured to regulate operation of the illumination portion, the camera, and the wireless transceiver or simply turn the device on or off.

In another exemplary embodiment, the end effector is controlled directly from the communication device.

In another exemplary embodiment, the memory stores additional instructions for execution by the processor that, when executed, further cause the processor to receive, via the wireless transceiver, a command from the communication device and execute the command. The command is one of a command to activate or deactivate the camera, a command to adjust one of an intensity or a wavelength of light emitted by the illumination portion, a command to increase or decrease speed of the drill, a command to grip an object via the robotic arm, a command to pick up the object, a command to drilling through the object, a command to zoom in or zoom out using the camera, a command to activate or deactivate the illumination portion.

### BRIEF DESCRIPTION OF THE DRAWINGS

The invention will now be described, by way of example, with reference to the accompanying drawings, in which:

FIG. 1A illustrates a side view of a smart stick assembly comprising a fully extended rod, in accordance with an exemplary embodiment of the present invention

FIG. 1B illustrates a side view of a smart stick assembly having a rod of an intermediate length, in accordance with an exemplary embodiment of the present invention.

FIG. 1C, illustrates a side view of a smart stick assembly having a compacted rod, in accordance with an exemplary embodiment of the present invention.

FIG. 2A illustrates a cross-sectional view of the rod, when battery being charged with a direct hard-wire, in accordance with an embodiment of the present invention.

FIG. 2B illustrates a cross-sectional view of the rod, when the battery being charged with a male-female coupling that enables charging when male and female connecters are pressed together.

FIG. 3 illustrates a perspective view of an exemplary distal end of the rod with an illumination portion and a camera, in accordance with an exemplary embodiment of the present invention.

FIG. 4 illustrates a perspective view of an exemplary distal end of rod being manipulated up to 270°, in accordance with an embodiment of the present invention.

FIG. 5A illustrates the illumination portion operating in a pickup stick lighting embodiment, in accordance with an embodiment of the present invention.

FIG. 5B illustrates the illumination portion operating in an extendable image capture device embodiment, in accordance with an embodiment of the present invention.

FIG. 6 illustrates an exemplary coupling mechanism detachably attached to the distal end (106a) of the rod, in accordance with an embodiment of the present invention.

FIG. 7 illustrates a magnet end effector coupled to the distal end, in accordance with an exemplary embodiment of the present invention.

FIG. 8 illustrates the robotic arm end effector pick up assembly coupled to the coupling mechanism of the distal end of the rod, in accordance with an exemplary embodiment of the present invention.

FIG. 9 illustrates an exemplary drill end effector, coupled to the distal end, in accordance with an exemplary embodiment of the present invention.

FIG.10A and FIG. 10B illustrates an exemplary operation of smart stick assembly, in accordance with an embodiment of the present invention.

FIG. 11A and FIG. 11B illustrates an exemplary operation of user pointing distal end of rod with camera into a drainage through which a small bolt has fallen, in accordance with an embodiment of the present invention.

FIG. 12A and FIG. 12B illustrates an exemplary operation of user orients distal end of rod with camera into an elevated cupboard to see what is behind the dishes with communication device displaying the recorded video in real time.

FIG. 13A and FIG. 13B illustrates an exemplary operation of user raises camera at distal end of rod to view leaves in a rain gutter at the edge of a roof. By which user enables the opportunity to determine whether the gutter requires cleaning.

FIG. 14A and FIG. 14B shows a basketball player dunking the ball, while the camera captures the image at the distal end of the rod.

FIG. 15A and FIG. 15B shows camera extended over a fence to view a lost pet.

FIG. 16A and FIG. 16B shows a group selfie photo that provides a wide view.

FIG. 17 illustrates a flow chart of the working of the smart stick assembly, in accordance with an exemplary embodiment.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part.

In one embodiment, the smart stick is a telescopically extendable rod that is configured, through a digital camera and LED lights at the rod's distal end, to generate images and video, which transmit to a communication device. Further, the rod enables functional engagement based on the images and video, through use of multiple interchangeable end effectors at the rod's distal end, which can be operated while viewing the images/video through the communication device.

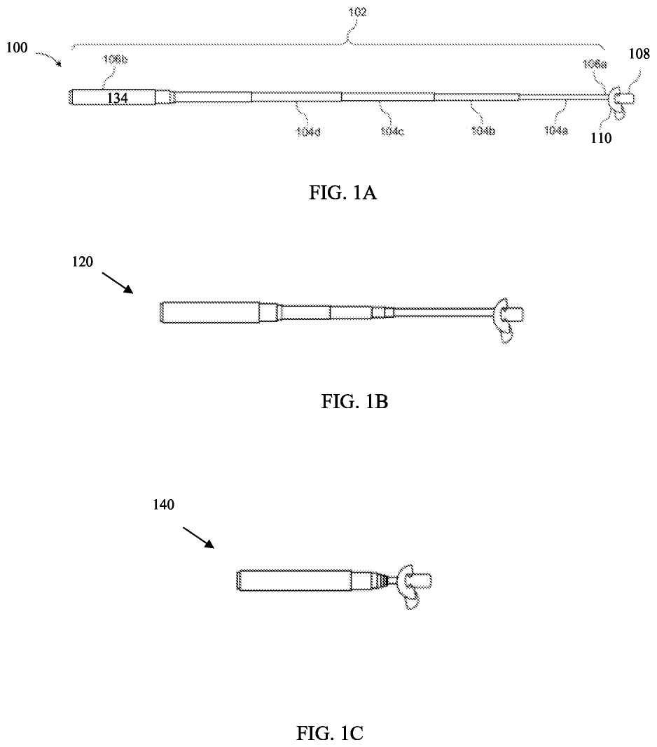

FIG. 1A illustrates a side view of a smart stick assembly (100) comprising a rod (102), in accordance with an exemplary embodiment of the present invention. The rod (102) is a fully extended rod. The fully extended rod (102) is most effective for reaching objects or performing functions at a great distance from the user. The smart stick assembly (100) comprises the rod (102) configured to pick up lost items and also enabled to capture images and videos. The rod (102) is an elongated member. The shape of rod (102) is at least one of them i.e., a cylindrical shape, a rectangular shape, a triangular shape, or a combination thereof extending along the length of the rod (102). The rod (102) comprises a plurality of sections (104a, 104b, 104c, 104d) that are slidably engaged to provide telescopic extension and retraction. Further, the rod (102) is extended and retracted on the basis of forced movement of the plurality of sections (104a, 104b, 104c, 104d) or gravity, or mechanical force. The rod (102) is shown with the plurality of sections (104a, 104b, 104c, 104d) fully extended in the telescopic configuration.

The rod (102) is having a proximal end (106b) and an opposing distal end (106a). The proximal end (106b) is grasped by a user during operation of the smart stick assembly (100). A coupling mechanism (110) is detachably attached to the distal end (106a) of the rod (102). A detachable end effector (108) is attached to the coupling mechanism (110). The detachable end effector is at least one of a magnet, robotic arm, and drill.

The rod (102) is configured to enable the functional engagement based on the images and video through utilization of multiple interchangeable end effectors (108). Further, the detachable end effector (108) is enabled to operate through a proximal end (106b) of the rod (102) via a switch (not shown). The proximal end (106b) of the rod comprises a rubber grip (134) encapsulating at least a portion of the length of the rod (102).

In one exemplary embodiment, the magnet is coupled to the distal end (106a) of the rod (102) to pick up lost items that are not easily viewable by the user due to darkness, location in small areas, and objects in small hard to reach spaces, like corners.

In another exemplary embodiment, the user can simply pull out the distal end (106a) of the rod (102) to extend the length, and conversely, push in the distal end (106a) towards the proximal end (106b) to shorten the length of the rod (102). In one embodiment, the rod (102) comprises a metal material.

FIG. 1B illustrates a side view (120) of the smart stick assembly having a rod of an intermediate length, in accordance with an exemplary embodiment of the present invention. As the distal end is telescopically pushed inwardly, an intermediate length rod is available for use. The intermediate length rod is useful when the distance to the desired function is not that great.

FIG. 1C, illustrates a side view (140) of the smart stick assembly having a compacted rod, in accordance with an exemplary embodiment of the present invention. When plurality of sections is fully compacted, the compacted rod is enabled to operate in cramped spaces.

In one exemplary embodiment, the rod forms a cavity that is sized and dimensioned to retain the electrical components. The cavity comprises a battery, a charging port, and at least one printed circuit board. The at least one printed circuit board comprising a processor, a wireless transceiver, a memory and, may include, without limitation, wires, resistors, capacitors, microchips, and conductive metals.

In one embodiment, the battery can be at proximal end, distal end, or any point therebetween inside cavity of the rod. The battery is configured to generate electrical power for powering other components of the smart stick assembly. The battery is operatively connected to at least one printed circuit board, so as to deliver electrical power to all components requiring electricity. The battery may include without limitation, a rechargeable battery, a coin battery, an alkaline battery, a nickel cadmium battery, and even a solar panel or photovoltaic cell.

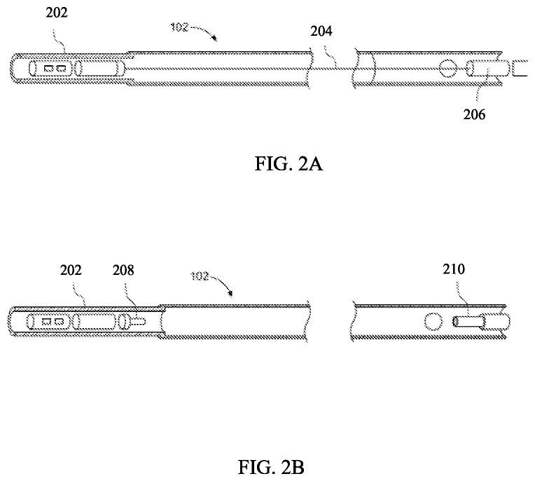

FIG. 2A illustrates a cross-sectional view of the rod (102), when battery (202) being charged with a direct hard-wire (204), in accordance with an embodiment of the present invention. The battery (202) is configured to generate the power and is disposed in the cavity. Further the battery (202) is operatively connected to the hard-wire (204) and circuitry subassembly. The battery (202) can be charged in multiple ways, and the charging means includes an internal connection, using a hard-wire (204), between the battery (202) and charging port (206) at the proximal end of the rod (102). The first charging means is a hard-wired connection that enables battery (202) to remain connected while USB cable performs charging functions. In this hard-wired (204) configuration, the hard-wire (204) is compressed when the rod (102) is retracts also the hard-wire (204) is compacts for stowage purpose.

FIG. 2B illustrates a cross-sectional view of the rod (102), when the battery (202) being charged with a male-female coupling that enables charging when male and female connecters are pressed together. The battery (202) is coupled to the male connector (208) and a charging portion is coupled to the female connector (210). When the stick is retracted, a connection is made between the male connector (208) and the female connector (210), which further enables the on/off/control button to function for external charging.

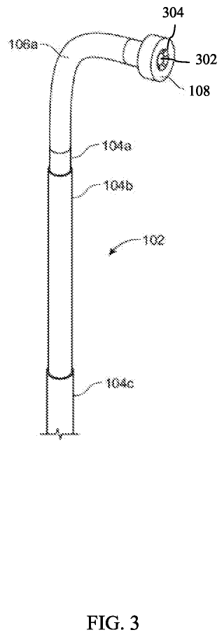

FIG. 3 illustrates a perspective view of an exemplary distal end (106a) of the rod (102) with an illumination portion (304) and a camera (302), in accordance with an exemplary embodiment of the present invention. The illumination portion (304) is operatively connected to the battery, so as to receive power therefrom. The illumination portion (304) is configured to illuminate, which enhances operation of the adjacently positioned camera (302). In one embodiment, the illumination portion (304) comprises a light emitting diode (LED). The LED can include an array of lights that cast a wide beam. In some embodiments, eclectic colors, patterns, and intensities of illumination can be used with the LED. For example, a bright white light can shine directly in front of distal end (106a) of the rod (102).

In one embodiment, the illumination portion (304) is represented by 6 LED light lens being manipulated up to 270°, so that the end effectors and components thereof have optimal range to perform the desired function. The distal end (106a) comprises a magnet serving as the end effector (108). A user can simply grasp the distal end (106a) and pull the terminus to the desired position with the 270° range. The rod (102) comprised of the plurality of sections (104a, 104b, 104c) that are slidably engaged to enable telescopic extension and retraction. In one non-limiting embodiment, the camera (302) is operationally disposed at the distal end (106a) of the rod (102). The camera (302) is configured to capture an image or a video. In an alternative embodiment, the camera (302) may also capture audio sounds use of a microphone. The camera (302) may include, without limitation, a digital camera, a mini camera, or a camera known in the art of medical surgical procedures. The camera (302) not only captures images and videos, but saves and transmits the file thereof for viewing in a communication device via the wireless transceiver. The images and/or videos are viewable through the communication device, even if the distance from the rod (102) is great. The communication device may include, without limitation, a personal smart phone, a laptop, a tablet, a computer, a remote processor, and a remote server. Thus, as an image is captured by the camera (302), it can simultaneously be viewed through the communication device. Furthermore, the transmitted image and video signals are inhibited from lagging through use of a high-speed Wi-Fi chip integrated into the printed circuit board.

In one exemplary embodiment, a switch operatively connects to the illumination portion, the camera, and the wireless transceiver. Switch may include a power switch for powering on and powering off the aforementioned components. The switch may also be a light intensity switch, a camera adjustment switch, an extension and retraction switch for the rod, or an end effector switch to control the end effector, described below. In this manner, switch is within a thumb's reach, at the distal end of the rod, to help regulate operation of the illumination portion, the camera, and the wireless transceiver. In some embodiments, the smart stick assembly also provides a USB cable that is configured to detachably connect the communication device to the charging port of the rod. In other embodiments, a charging connector is disposed between battery and the charging port. The charging connector may include a conductive section metal that is configured to enable electrical connectivity between the battery and the USB cable. This enhances charging of the battery.

In yet another embodiment, a sensor is coupled to the camera to stabilize the camera during motion. The sensor is a gyroscope. The gyroscope may be a 3-axis gyroscope that stabilizes camera during motion. In one embodiment, the gyroscope encapsulates the camera and holds the camera in a relative position to the center of the distal end of the rod. In this manner, while cameras operate, the captured image and video are viewable with minimal ancillary vibrations and motion.

Furthermore, since camera can be used as an extendable image capture device, i.e., selfie stick, in which the magnet is not utilized. The use of a stabilizing gyroscope and other image stabilization technology with the camera of the extendable image capture device the quality of the image or video is greatly enhanced through such stabilizing means. It is significant to note the smart stick assembly can be used as an extendable image capture device without using the magnet end effector, or any other end effectors. In this configuration, the smart stick assembly is in essence, an extendable and retractable selfie stick with a built-in camera.

In yet another exemplary embodiment, the smart stick assembly allows the user to keep the phone in hand to see images from the smart stick from up to one hundred feet away or more, with having zoom capabilities.

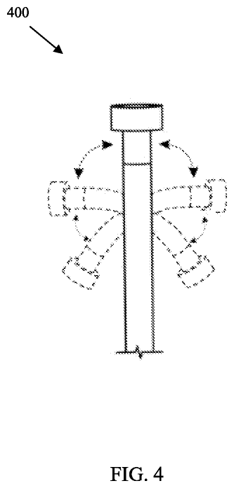

FIG. 4 illustrates a perspective view (400) of a flexible distal end of the rod, configured to rotate up to 270° in relation to the non-flexible proximal end of the rod, in accordance with an embodiment of the present invention. The broken lines and double sided arrows in FIG. 4 depict possible positions of the flexible distal end of the rod.

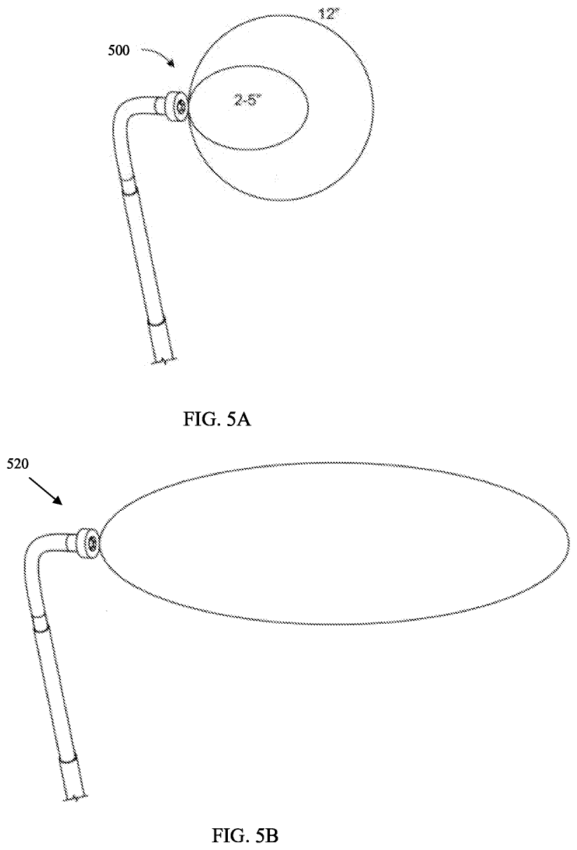

FIG. 5A illustrates the illumination portion operating in a pickup stick lighting (500), in accordance with an embodiment of the present invention. The illumination portion operating in a pickup stick lighting (500), in which a typical LED lights shine about a 12″ maximum light field, and a 2″-5″ intense light. The intense of light can be adjusted through switch. The range of illumination can vary dependent on the LED light.

FIG. 5B illustrates the illumination portion operating in an extendable image capture device (520), in accordance with an embodiment of the present invention. For selfie lighting configurations, the figure shows the light focus between 1′-over 100′ away, or infinity; and the natural light used for illuminating larger areas. The intensity of light from illumination portion can be adjusted through switch to achieve a desired lighting effect.

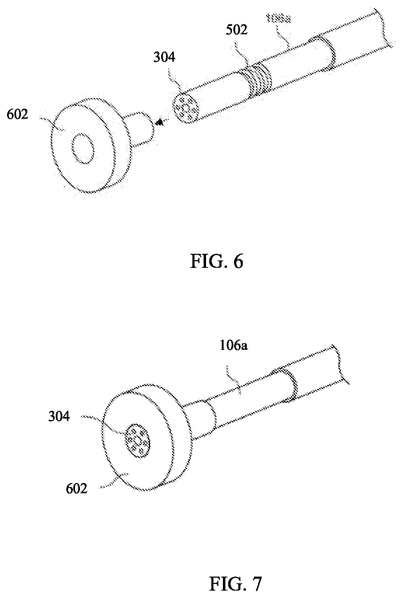

FIG. 6 illustrates an exemplary coupling mechanism (502) detachably attached to the distal end (106a) of the rod, in accordance with an embodiment of the present invention. The coupling mechanism (502) comprises a cylindrical shaft with a depression, inner threaded surface, socket hole, and mechanical coupling port. The cylindrical shaft with a depression, inner threaded surface, socket hole, and mechanical coupling port is configured to slidably engage with the distal end (106a) of the rod from one end. Moreover, the cylindrical shaft with depression, inner threaded surface, socket hole, and mechanical coupling port is configured to slidably engage the magnet end effector (602) from the opposite end.

With reference to FIGS. 7, 8 and 9, the coupling mechanism may simply be a threaded section of the distal end (106a) that rotatably receives the desired end effectors (602, 802, 902). Multiple interchangeable end effectors (602, 802, 902) are detachably attach to the coupling mechanism (502). The end effectors (602, 802, 902) are configured to perform an action from the distal end (106a) of the rod. The action may include picking up a metal object, where the end effector (602) is a magnet, gripping an object, where the end effector (802) is a robotic arm and drilling through an object, where the end effector is a drill end effector (902). Furthermore, the camera (304) is enabled to utilized as an extendable image capture device, i.e., selfie stick, in which the magnet (602) is not utilized.

FIG. 7 illustrates a magnet end effector (602) coupled to the distal end (106a), in accordance with an exemplary embodiment of the present invention. The illumination portion (304) is configured to illuminate the area while using the magnet end effector (602). The magnet end effector (602) is configured to attract, and thereby pickup metal objects. The magnet end effector (602) is easily manipulated from distal end of rod to pick up metal objects such as pins, a set of keys, bolt, or any other metal object.

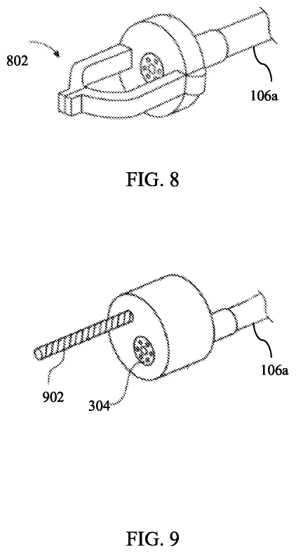

FIG. 8 illustrates the robotic arm end effector (802) coupled to the coupling mechanism of the distal end (106a), in accordance with an exemplary embodiment of the present invention.

FIG. 9 illustrates an exemplary drill end effector (902), coupled to the distal end (106a), in accordance with an exemplary embodiment of the present invention. A controller can be used to regulate drill end effector (902) for drilling operations. The user is enabled to view images, or videos of drilling captured by the camera (304).

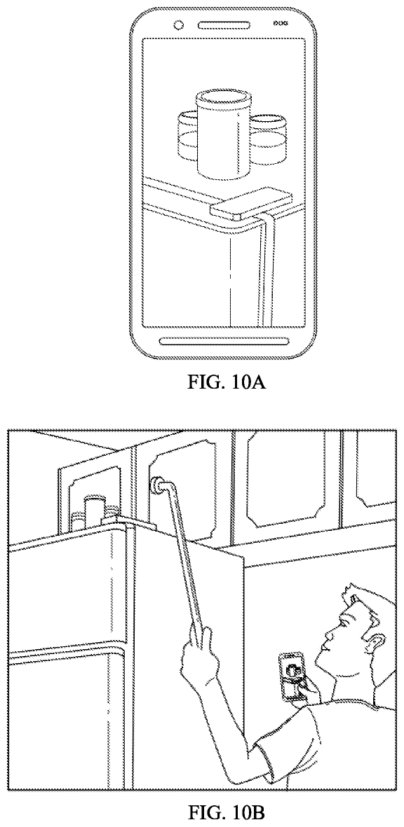

FIG.10A and FIG. 10B illustrates an exemplary operation of the smart stick assembly, in accordance with an embodiment of the present invention. The user orients distal end of rod with the camera on top of a refrigerator to see what is there with communication device displaying the recorded video in real time.

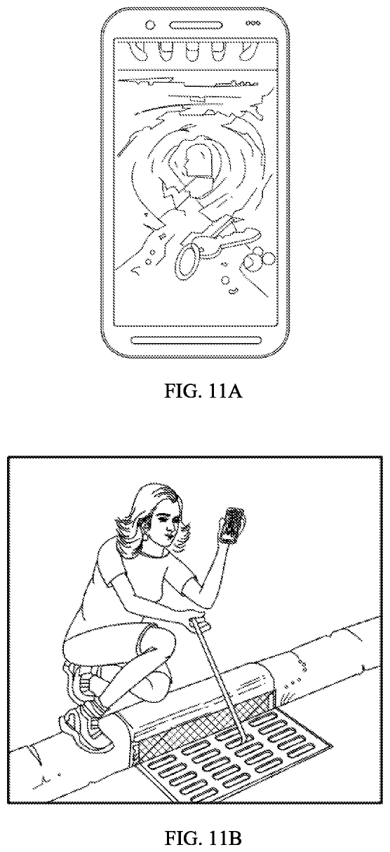

FIG. 11A and FIG. 11B illustrates an exemplary operation of user pointing distal end of rod with the camera into a drainage through which a small bolt has fallen, in accordance with an embodiment of the present invention. The users are enabled to add a magnet to the distal side of the coupling mechanism. Further, the user is configured to points the distal end of the rod towards the object, and begins recording the video. The video is simultaneously transmitted to the communication device of the user for viewing. The magnet can then be manipulated, with the help of visual indications on the communication device, to engage the bolt with the magnet, and retract the bolt. As illustrated in FIG. 11B, the user is watching the communication device while simultaneously manipulating the distal end of rod.

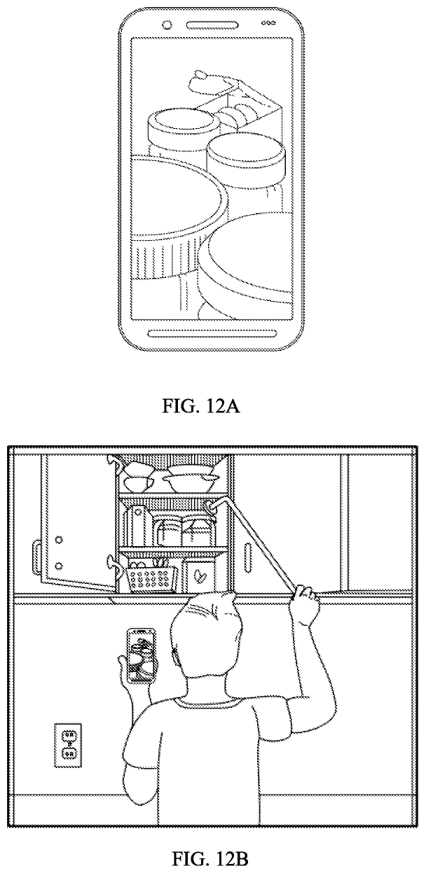

FIG. 12A and FIG. 12B illustrates an exemplary operation of the user orients distal end of the rod with the camera into an elevated cupboard to see what is behind the dishes with the communication device displaying the recorded video in real time. In yet another example of operation of the smart stick assembly, shown in FIG. 12, the user orients distal end of the rod with the camera on top of the refrigerator to see what is there with the communication device displaying the recorded video in real time.

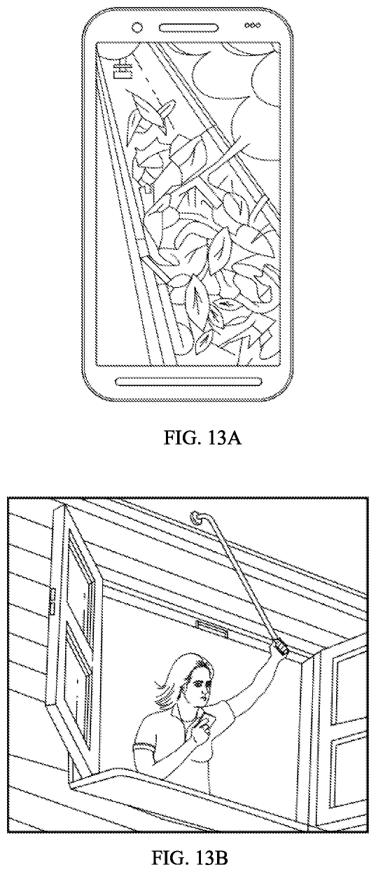

FIG. 13A and FIG. 13B illustrates an exemplary operation of the user raises the camera at the distal end of the rod to view leaves in a rain gutter at the edge of a roof. By which user enables the opportunity to determine whether the gutter requires cleaning.

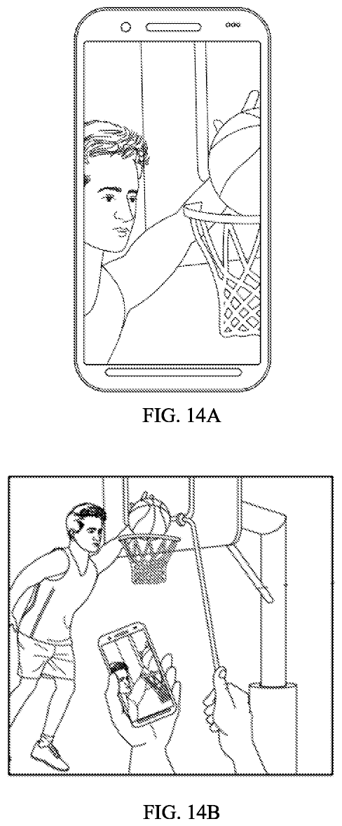

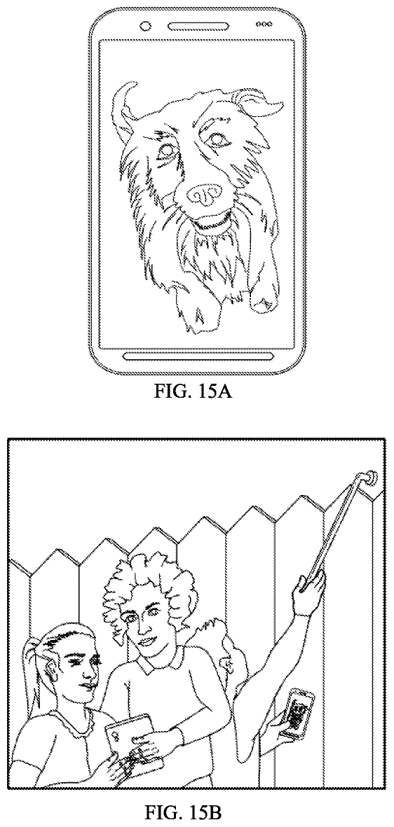

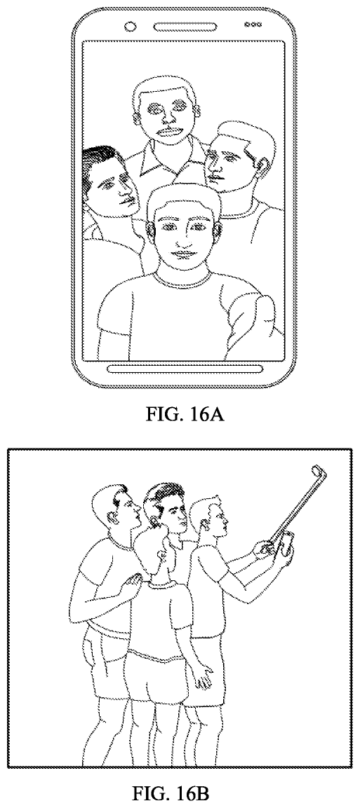

With reference to FIG. 14-FIG. 16, the smart stick assembly is used with no end effectors, serving primarily as the extendable image capture device or some sort of a lighting and video capturing tool. The invention is especially useful for capturing videos in the edict of the image capture. The smart stick assembly allows the user to keep their phone and their hand to see images from the smart stick assembly up to one hundred feet away. FIG. 14A and FIG. 14B shows a basketball player dunking the ball, while the camera captures the image at the distal end of rod. FIG. 15A and FIG. 15B shows the camera extended over a fence to view a lost pet, for example FIG. 16A and FIG. 16B shows a group selfie photo that provides a wide view, since the rod can be extended 39″, or in some embodiments, longer.

It is significant to note that processor can have integrated therein software that controls and turns on/off camera. Software can also control light from illumination portion, and end effectors that are attached to the distal end of rod, i.e., magnet, robotic arm, drill, etc. In this manner, a first user can hold the rod and move it, while a second user can control the illumination portion and end effectors from a smart phone, for example.

While being used in the capacity of an extendable image capture device, illumination portion at the distal end of the rod can serve as a flash, and can also provide varying amounts of lighting to accommodate the requirements of the camera, or lighting for functional operations, such as picking up metal objects with the magnet end effector. For example, the illumination portion operating in a pickup stick lighting embodiment, in which the LED lights shine a 12″ maximum light field, and a 2″-5″ intense light. This can be adjusted through switch. For selfie lighting configurations, the light focus between 1′-over 100′ away, or infinity; and the natural light is used for illuminating larger areas. However, as discussed above, the intensity of light from illumination portion can be adjusted through switch to achieve a desired lighting effect.

In another exemplary embodiment, the end effector is controlled directly from the communication device.

In another exemplary embodiment, the memory stores additional instructions for execution by the processor that, when executed, further cause the processor to receive, via the wireless transceiver, a command from the communication device and execute the command. The command is one of a command to activate or deactivate the camera, a command to adjust one of an intensity or a wavelength of light emitted by the illumination portion, a command to increase or decrease speed of the drill, a command to grip an object via the robotic arm, a command to pick up the object, a command to drilling through the object, a command to zoom in or zoom out using the camera, a command to activate or deactivate the illumination portion.

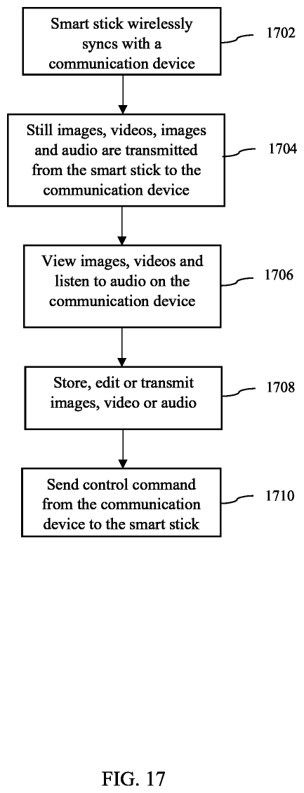

FIG. 17 illustrates a flow chart (1700) of the working of the smart stick assembly, in accordance with an exemplary embodiment. At step (1702), the smart stick assembly wirelessly syncs with a communication device. At step (1704), the smart stick is configured to transmit the still images, videos, images, and audio to the communication device. At step (1706), the user is enabled to view images, videos, and listen to audio on the communication device. At step (1708), the user of the communication device is enabled to store, or edit the images, audio or video transmitted by the smart stick. In one example, the user of the communication device is enabled to transmit the images, audio, or video to another device or cloud. At step (1710), the user of the communication device is enabled to transmit one or more control commands to the smart stick.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention.

What is claimed is:

1. A smart stick assembly comprising:
a rod having a proximal end and an opposing distal end,
wherein the rod comprising a battery, a charging port, and at least one printed circuit board;
wherein the at least one printed circuit board comprising a processor, a wireless module, and a memory;
an illumination portion, disposed at the distal end of the rod, configured to illuminate;
a camera, disposed at the distal end of the rod, configured to capture an image, or a video, or both;
a sensor coupled to the camera to stabilize the camera during motion,
wherein the camera is configured to transmit the captured image and video to a remote communication device through the wireless transceiver,
a detachable end effector coupled to the distal end of the rod and configured to perform an action; and
a control unit disposed at the proximal end of the rod, and in operational communication with the detachable end effector, whereby the end effector is controlled directly from the rod.

2. The assembly of claim 1, wherein the assembly further comprises a rubber grip encapsulating at least a portion of the length of the rod.

3. The assembly of claim 1, wherein the rod comprises a plurality of telescopic sections.

4. The assembly of claim 1, wherein the sensor is an image stabilization technology device.

5. The assembly of claim 4, wherein the image stabilization technology device is a gyroscope.

6. The assembly of claim 1, wherein the illumination portion comprises one or more light emitting diodes.

7. The assembly of claim 1, further comprising a charging connector disposed between the battery and the charging port, wherein the charging connector is configured to enable electrical connectivity between the battery and the cable.

8. The assembly of claim 1, wherein the charging port of the rod comprises a USB port.

9. The assembly of claim 1, further comprising a cable configured to detachably connect the communication device to the charging port of the rod.

10. The assembly of claim 1, wherein the detachable end effector is at least one of a magnet, robotic arm, and drill.

11. The assembly of claim 1, wherein the camera is configured to capture image or video with minimal ancillary vibrations and motion.

12. The assembly of claim 1, further comprising a switch operatively coupled to at least one of the illumination portion, the camera, and the wireless transceiver, wherein the switch is configured to regulate operation of the illumination portion, the camera, and the wireless transceiver.

13. The assembly of claim 1, wherein the end effector is controlled directly from the communication device.

14. The assembly of claim 1, wherein the memory stores additional instructions for execution by the processor that, when executed, further cause the processor to:
receive, via the wireless transceiver, a command from the communication device and execute the command.

15. The assembly of claim 1, wherein the command is one of a command to activate or deactivate the camera, a command to adjust one of an intensity or a wavelength of light emitted by the illumination portion, a command to increase or decrease speed of the drill, a command to grip an object via the robotic arm, a command to pick up the object, a command to drilling through the object, a command to zoom in or zoom out using the camera, a command to activate or deactivate the illumination portion.

16. The assembly of claim 1, wherein the detachable end effector is attached to a flexible distal end of the rod, configured to rotate up to 270° in relation to the proximal end of the rod.
